(19) United States
(12) Patent Application Publication
(10) Pub. No.: US 2013/0286388 A1
(43) Pub. Date: Oct. 31, 2013

(54) FIELD CONCENTRATING SURFACE ENHANCED RAMAN SPECTROSCOPY PLATFORMS

(71) Applicants: Alexandre M. Bratkovski, Mountain View, CA (US); Jacob Khurgin, Pikesville, MD (US)

(72) Inventors: Alexandre M. Bratkovski, Mountain View, CA (US); Jacob Khurgin, Pikesville, MD (US)

(21) Appl. No.: 13/455,611

(22) Filed: Apr. 25, 2012

(51) Int. Cl. G01J 3/44

(52) U.S. Cl. 356/301

(57) ABSTRACT

A field concentrating surface enhanced Raman spectroscopy (SERS) platform includes a signal amplifying material and a pattern of apertures extending through the signal amplifying material. The pattern of apertures includes a central aperture, and a plurality of radiation capturing apertures positioned around the central aperture. Each of the radiation capturing apertures has a diameter that is larger than a diameter of the central aperture. The platform further includes a substrate that supports the signal amplifying material and a channel that extends through the substrate. The channel is at least partially aligned with the central aperture that extends through the signal amplifying material.

### BACKGROUND

Assays and other sensing systems have been used in the chemical, biochemical, medical and environmental fields to detect the presence and/or concentration of a chemical species. Some sensing techniques utilize color or contrast for species detection and measurement, including, for example, those techniques based upon reflectance, transmittance, fluorescence, or phosphorescence. Other sensing techniques, such as Raman spectroscopy or surface enhanced Raman spectroscopy (SERS), study vibrational, rotational, and other low-frequency modes in a system. In particular, Raman spectroscopy is used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matters has characteristic peaks that can be used to identify the species.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a semi-schematic, perspective view of an example of a field concentrating surface enhanced Raman spectroscopy (SERS) platform;

FIG. 1B is a semi-schematic, perspective view of another example of a field concentrating surface enhanced Raman spectroscopy (SERS) platform;

FIG. 1C is a semi-schematic, perspective view of still another example of a field concentrating surface enhanced Raman spectroscopy (SERS) platform;

FIG. 2 is a top view of an example of a pattern of apertures for an example of the field concentrating SERS platform;

FIG. 3A is a top view of another example of a field concentrating SERS platform including an array of plasmonic lenses, each of the plasmonic lenses including the pattern of apertures shown in FIG. 2;

FIG. 3B is a cross-sectional view of the field concentrating SERS platform taken along line 3B-3B in FIG. 3A;

FIG. 4 is a semi-schematic cross-sectional view of the field concentrating SERS platform of FIG. 3B with a microfluidic system operatively attached thereto;

FIG. 5 is a schematic and partially cross-sectional view of an example of a surface enhanced Raman spectroscopy (SERS) sensing system; and

FIG. 6 is a schematic and partially cross-sectional view of another example of the SERS sensing system.

### DETAILED DESCRIPTION

The present disclosure relates generally to field concentrating SERS platforms. Examples of the platforms disclosed herein include hollow apertures that extend through a signal amplifying material. The apertures are formed in a pattern that enhances the concentration of optical fields in a central one of the apertures. The pattern is controllable so that all of the apertures have a similar shape, but so that the size of the apertures increase in a direction moving outward from the central aperture. The larger apertures of the pattern may serve as an antenna for capturing the electromagnetic energy, from which resonant transfer would move the energy to progressively smaller apertures. This controlled pattern enables the gradual concentration of energy at the central aperture, which becomes a hot spot that is useful for SERS. The Raman enhancement that is achieved is due partially to the field concentration and partially to an increase in density of states. In particular, the Raman enhancement is proportional to the square of concentration of the pump field (i.e., field of incoming laser) and the square of enhancement of the vacuum field at the Stokes frequency (i.e., field of a single photon in the optical mode defined by the central aperture).

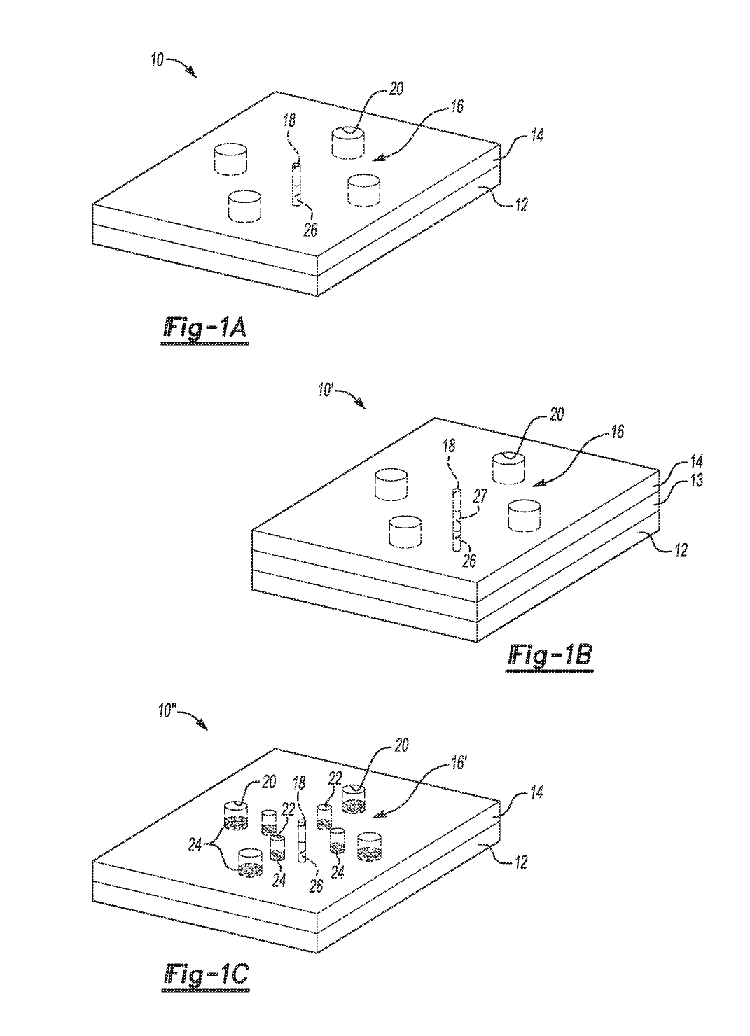

Referring now to FIGS. 1A and 1B, two examples of the field concentrating SERS platform 10, 10′ are respectively depicted. It is to be understood that methods for forming examples of the SERS platform 10, 10′ will be discussed in further detail hereinbelow.

Each of the platforms 10, 10′ includes a substrate 12 and a signal amplifying material 14 supported by the substrate 12. The example of FIG. 1A includes the signal amplifying material 14 directly supported by the substrate 12, and the example of FIG. 1B includes a waveguide 13 positioned between signal amplifying material 14 and the substrate 12.

The substrate 12 may be any suitable material, such as silicon, silicon dioxide (SiO₂), germanium, glass, quartz, nitrides, alumina, sapphire, indium tin oxide (ITO), polymers (e.g., polyethylene terephthalate (PET), polyethylene terephthalate glycol-modified (PETG), polypropylene, polyethylene, polycarbonate, polyimide, acrylic, etc.), combinations thereof, and/or layers thereof.

The signal amplifying material 14 is supported by the substrate 12, whether the two 12, 14 are in direct contact (FIG. 1A) or in indirect contact (FIG. 1B). The signal amplifying material 14 may be any material that is capable of enhancing the Raman signal that is generated during sensing. For example, the signal amplifying material 14 is a Raman signal-enhancing material (composition of matter) that increases the number of Raman scattered photons when a molecule (or other species of interest) settles on the material 14 in or near the central aperture 18, and when the molecule and material 14 are subjected to light/electromagnetic radiation. Raman signal-enhancing materials include, but are not limited to, silver, gold, aluminum, and copper. Other noble metals may also be used, such as platinum, palladium, etc. If silver is utilized, it may be desirable to passivate the outer surfaces with aluminum nitrate to keep the silver from diffusing. In an example, the thickness of the signal amplifying material 14 ranges from about 20 nm to about 90 nm.

The signal amplifying material 14 has a pattern 16 of apertures 18, 20 formed therein. Each of the apertures 18, 20 extends through the thickness of the signal amplifying material 14. In the example shown in FIGS. 1A and 1B, the pattern 16 includes the central aperture 18 and a plurality of radiation capturing apertures 20 positioned around the central aperture 18. It is to be understood that each of the apertures 18, 20 is a discrete aperture that is physically separated from each other aperture 18, 20 by at least some of the signal amplifying material 14.

In an example, each of the radiation capturing apertures 20 is spaced from the central aperture 18 about the same distance as each of the other radiation capturing apertures 20. The equidistant positioning may contribute to more evenly concentrated energy around and toward the central aperture 18. While four radiation capturing apertures 20 are shown in FIGS. 1A and 1B, it is to be understood that any number of radiation capturing apertures 20 may surround the central aperture 18. For example, a triangular arrangement may be formed where three radiation capturing apertures 20 surround the central aperture 18. The number of radiation capturing apertures 20 included may be limited by the diameter selected for the radiation capturing apertures 20. Since the radiation capturing apertures 20 function as antenna for an external field exposed thereto, it may be desirable that all of the radiation capturing apertures 20 have about the same diameter and about the same shape (taking into account minor variations that may result during manufacturing). These diameters may be dependent upon the wavelength, λ, of light that is to be used to interrogate the field concentrating SERS platform 10, 10′. In an example, the diameter of each of the radiation capturing apertures 20 is a fraction of λ that is suitable for capturing radiation. In an example including a diamond arrangement including four radiation capturing apertures 20, the diameter of each radiation capturing aperture 20 may be about ¼*λ or λ/4, and the diameter of the central aperture 18 may be about 1/36*λ or λ/36. In an example including a triangular arrangement including three radiation capturing apertures 20, the diameter of each radiation capturing aperture 20 may be about ¼*λ or λ/4, and the diameter of the central aperture 18 may be about 1/16*λ or λ/16.

As illustrated in FIGS. 1A and 1B, the diameter of each of the radiation capturing apertures 20 is larger than the diameter of the central aperture 18. Since it is desirable that any captured energy be concentrated at the central aperture 18, the diameter of the central aperture 18 may be the smallest of all the apertures 18, 20 in the pattern 16. The diameter of the central aperture 18 may also be dependent upon the wavelength, λ, of light that is to be used to interrogate the field concentrating SERS platform 10, 10′. In an example, the diameter of the central aperture 18 may be about 1/36*λ or λ/36. In this example, when a wavelength of 785 nm is to be used for SERS interrogation, the diameter of the central aperture 18 may be 22 nm, and when a wavelength of 1064 nm is to be used for SERS interrogation, the diameter of the central aperture 18 may be 30 nm. In other examples, it may be desirable that the diameter of the central aperture 18 be about 1/16*λ or λ/16.

The shapes of the apertures 18, 20 may contribute to achieving the desirable energy concentration at the central aperture 18. In an example, the shapes of each of the apertures 18, 20 in the pattern 16 are substantially similar. The substantially similar shapes enable resonant transfer, which moves the energy from larger shapes to progressively smaller shapes. In an example, the shapes are circular or oval. Substantially similar shapes include the same shape and shapes having up to 10% fabrication error with respect to one another.

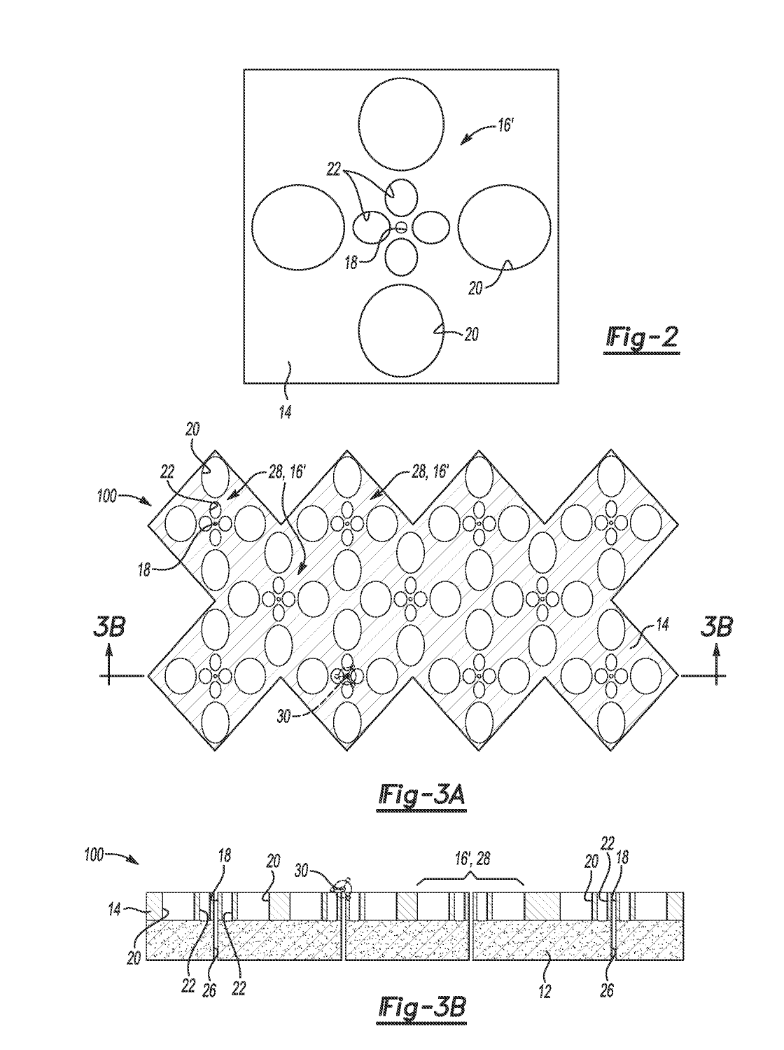

The pattern 16 shown in FIGS. 1A and 1B includes two different apertures, namely the central aperture 18 and the surrounding radiation capturing apertures 20. Another example pattern 16′ is shown in FIG. 2. This example pattern 16′ includes the central aperture 18, the radiation capturing apertures 20, and radiation concentrating apertures 22 positioned between the central aperture 18 and the radiation capturing apertures 20. As illustrated, the radiation concentrating apertures 22 surround the central aperture 18, and the radiation capturing apertures 20 surround the radiation concentrating apertures 22. Each of the apertures 18, 20, 22 extends through the thickness of the signal amplifying material 14.

In an example, each of the radiation concentrating apertures 22 is spaced from the central aperture 18 about the same distance as each of the other radiation concentrating apertures 22. Similarly, respective radiation capturing apertures 20 are spaced from an adjacent radiation concentrating aperture 22 about the same distance. In an example, each of the radiation concentrating apertures 22 is about 2 nm from the central aperture 18, and each of the radiation capturing apertures 20 is about 5 nm from an adjacent radiation concentrating aperture 22. The distance between any of the apertures 18 and 20, 18 and 22, or 20 and 22 may range from about 2 nm to about 10 nm. The distance may be limited, for example, by the fabrication process used. In some instances, it may be desirable that closer distances be utilized.

While four radiation concentrating apertures 22 are shown in FIG. 2, it is to be understood that any number of radiation concentrating apertures 22 may surround the central aperture 18. In some instances, it may be desirable to have the same number of radiation concentrating apertures 22 as there are radiation capturing apertures 20. When radiation concentrating apertures 22 are included, it is desirable that three apertures (i.e., the central aperture 18, one radiation concentrating aperture 22, and one radiation capturing aperture 20) lie on any line drawn from the center to the periphery. The number of radiation concentrating apertures 22 included may be limited by the diameter selected for the radiation concentrating apertures 22, and by the amount of space available between the central aperture 18 and the radiation capturing apertures 20. Since the radiation concentrating apertures 22 function as field concentrators for captured energy, it may be desirable that all of the radiation concentrating apertures 22 have about the same diameter and about the same shape (taking into account minor variations that may result during manufacturing). These diameters may be dependent upon the wavelength, λ, of light that is to be used to interrogate the field concentrating SERS platform 10, 10′.

In an example, the diameter of each of the radiation concentrating apertures 22 is a fraction of λ that is suitable for concentrating radiation. Generally, the diameter of each of the radiation concentrating apertures 22 is greater than the diameter of the central aperture 18 and is smaller than the diameter of each of the radiation capturing apertures 20. In an example, the diameter of each radiation concentrating aperture 22 may be about 1/12*λ or λ/12. Although, it is to be understood that the diameter of the radiation concentrating apertures 22 may be varied depending, at least in part, on the desired geometry and the fabrication process used.

In an example pattern 16′, the central aperture 18 has a diameter of about 3 nm, each of the radiation concentrating apertures 22 has a diameter of about 10 nm and is spaced from the central aperture 18 by about 2 nm, and each of the radiation capturing apertures 20 has a diameter of about 30 nm and is spaced from an adjacent radiation concentrating aperture 22 by about 5 nm. The period of this example pattern 16′ is about 100 nm, which is sub-wavelength to avoid diffraction and/or photonic band gap issues. In this example, the diameters of the apertures 20, 22, 18 cascade in size in a ratio of about 3:1 (e.g., 30 nm:10 nm, 10 nm:3 nm).

While the pattern 16′ shown in FIG. 2 is a diamond-shaped lattice, it is to be understood that the apertures 18, 20, 22 may also be formed as a triangular-shaped lattice.

Both the patterns 16 and 16′ shown in FIGS. 1A, 1B, and 2 may be suitable field concentrators for the platform 10, 10′. Energy divides equally between the apertures, as such, the electric field will be larger in the smaller apertures (e.g., 22 and 18). In the pattern 16, the field jump would be larger compared to the field jump involved with the pattern 16′. While this pattern 16 may render the platform 10, 10′ slight less efficient in terms of energy concentration, this pattern 16 may also result in a gain in intensity due to the larger amount of signal amplifying material 14 present between the apertures 18, 20 in this pattern 16. Due to the presence of more continuous apertures 18, 20, 22, where the apertures 22 effectively form a first coordination shell and the apertures 20 effectively form a second coordination shell around the central aperture 18, the pattern 16′ may more efficiently concentrate energy than the pattern 16. As such, the pattern 16, 16′ may be selected based, at least in part, upon the desirable performance of the platform 10, 10′. Similarly, the patterns 16, 16′ may be varied in other ways in order to achieve desirable effects.

Referring back to FIGS. 1A and 1B, the central aperture 18 and the radiation capturing apertures 20 remain hollow. When radiation concentrating apertures 22 are included, it is to be understood that these apertures 22 also remain hollow.

Also shown in FIGS. 1A and 1B is a channel 26 that extends through the substrate 12 and at least partially aligns with the central aperture 18 formed in the signal amplifying material 14. The channel 26 and central aperture 18 are in selective fluid (i.e., liquid or gas) communication so that fluid containing an analyte of interest may be delivered through the channel 26 and into the central aperture 18. The channel 26 may have the same diameter as the central aperture 18, or the diameter of the channel 26 may be larger or smaller than the diameter of the central aperture 18.

As mentioned above, the platform 10′ of FIG. 1B includes the waveguide 13 positioned between the substrate 12 and the signal amplifying material 14. The apertures 18, 20 (and 22 when included) extend through the thickness of the signal amplifying material 14. The channel 26 is formed in the substrate 12 as previously described, and an intermediate channel 27 is formed in waveguide 13. The intermediate channel 27 fluidly connects the central aperture 18 and the channel 26, so that fluid containing an analyte of interest may be to the central aperture 18 via the channels 26 and 27.

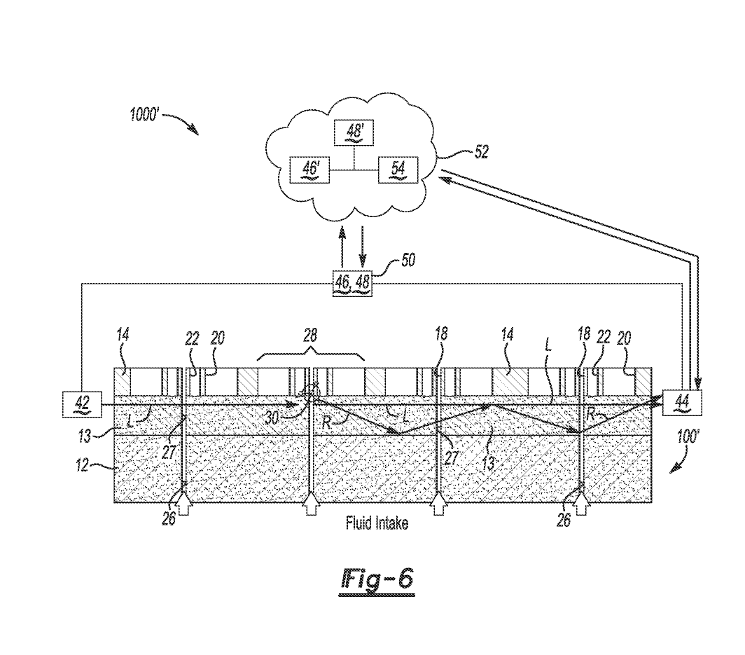

The waveguide 13 may be made of any material that has a higher refractive index than the refractive index of the substrate 12 that is utilized. As will be described further in reference to FIG. 6, the waveguide 13 may be utilized to light to the central apertures 18 during a SERS sensing operation. Selecting a waveguide 13 that has an average refractive index that is higher than its surroundings will ensure that light does not leak out of the waveguide 13. The effective or average index may be tailored to tune the waveguide 13 to some range of wavelengths of interest (e.g., visible, infrared, etc.). Suitable waveguide 13 materials include silicon dioxide (SiO₂), silicon nitride (Si₃N₄), or compound semi-conductors (e.g., indium phosphide, indium gallium arsenide, etc.). In an example, the substrate 12 selected is silicon dioxide, and the waveguide 13 selected is silicon nitride.

Referring now to FIG. 1C, another example of the platform 10″ is depicted with pattern 16′. In this example, the radiation capturing apertures 20 and the radiation concentrating apertures 22 are partially filled with a dielectric material 24. While shown in the example of FIG. 1C, it is to be understood that in any of the examples disclosed herein, it may be desirable to partially fill the larger apertures 20 or 20 and 22 with the dielectric material 24. Examples of suitable dielectric materials include silicon dioxide (SiO₂), silicon nitride (Si₃N₄), or aluminum oxide (Al₂O₃). As shown in FIG. 1C, when the larger apertures 20, 22 are partially filled with the dielectric material 24, the shape of the apertures 20, 22 may be adjusted (i.e., compressed, deformed, stretched, etc.) so that the desired resonant frequency of the apertures 20, 22 is not altered. If the filling factor of the aperture 20, 22 is “f” with the material 24 having a refractive index “n” (at a frequency of interest), then the apertures 20, 22 may be compressed in the radial direction or the azimuthal direction (the latter being analogous to stretching along the radial direction) by

$$\frac{δ l}{l} = - f ( n - 1 ) .$$

As an example, if 25% of each aperture 20, 22 (f=¼) is filled with SiO₂ (n=1.55), then

$$\frac{δ l}{l} = - 0.25 ( 1.55 - 1 ) = - 0.14 ,$$

which equates to shrinking the of each of the apertures 20, 22 by 14% uniformly (i.e., in all directions). In another example, the apertures 20, 22 may be compressed by about 15% when Al₂O₃ is used to fill about 20% of the apertures 20, 22.

In some of the examples disclosed herein, the surface of the central aperture 18 and/or the surface of areas of the signal amplifying material 14 surrounding the opening(s) to the central aperture 18 may be functionalized to be more selective to analyte(s) of interest. Functionalization involves the modification of the surface with molecules or ions that exhibit a twofold chemical functionalization, namely the molecules or ions include groups that can interact with the signal amplifying material 14 and also include other groups that will be exposed to any introduced fluid and are capable of attaching to analyte(s) of interest that are within the fluid. To attach (e.g., via absorption, bonding, etc.) the molecules or ions to the surface(s), the central aperture 18 and/or the areas of the signal amplifying material 14 surrounding the opening(s) to the central aperture 18 may be exposed to a solution containing the molecules or ions under conditions that allow the molecules or ions to interact with and attach to the surface(s).

The platforms 10, 10′ may be formed by a variety of methods, each of which will now be described. In one example method, a tool having a replica of the pattern 16, 16′ is used to punch the apertures 18, 20, and in some instances 22, in a continuous film of the signal amplifying material 14. The signal amplifying material 14 may be adhered to the substrate 12 or to the waveguide 13 (which is adhered to the substrate 12). In an example, masking and etching may be used to form the channel 26 through the substrate 12 so that the channel 26 is at least partially aligned with the central aperture 18. In another example, masking and etching may be used to form the channel 26 through the substrate 12 and the intermediate channel 27 through the waveguide 13 so that the channels 26 and 27 are at least partially aligned with the central aperture 18. In these examples, the mask includes an opening that at least partially corresponds with the central aperture 18 (both in size and location with respect to edges of the mask). The mask may be placed on the substrate 12 at a surface opposed to the surface upon which the punched signal amplifying material 14 or waveguide 13 is placed. When the mask is in place, the substrate 12 or substrate 12 and waveguide 13 may be etched through the opening in the mask to form the channel 26 or the channels 26 and 27. Once the channel 26 or channels 26 and 27, is/are formed, the mask may be removed. The etchant (e.g., HF etch) selected to form the channels 26 or 26 and 27 does not etch the metal selected as the signal amplifying material 14. In other examples, the central aperture 18 and the corresponding channel 26 or channels 26 and 27 are formed by focused ion beam or helium lithography (described below).

In another example method, the signal amplifying material 14 may be deposited on the substrate 12 or on the waveguide 13, which is then adhered to the substrate 12. In this example, nanoimprinting may be used to form the apertures 18, 20, 22 by transferring the pattern from a master to form a mask, and then using dry etching to form the respective apertures in the signal amplifying material 14 that underlies the mask. A UV or thermally curable polymer (that will become the mask) may be deposited on the signal amplifying material 14. Each of these deposition processes may be accomplished using, for example, spin coating, drop coating, or the like. In this example, the pattern 16, 16′ may be created using a combination of nanoimprinting and etching.

In this example, a mold is used that has features that are the desired size and shape of the apertures 18, 20, and in some instances 22, to be formed. In other words, the mold has a negative replica of the apertures 18, 20, and in some instances 22, of the pattern 16, 16′. This mold is placed into contact with the UV or thermally curable polymer to transfer the pattern 16, 16′ of apertures to the UV or thermally curable polymer. While the mold is in contact with the UV or thermally curable polymer, the polymer is cured or partially cured. The mold is then removed and curing is completed if necessary, and the cured polymer is a mask having the pattern 16, 16′ defined therein. Multiple etching steps may then be performed while the mask is in place to etch the pattern 16, 16′ into the signal amplifying material 14, and to etch the channel 26 into the substrate 12 or to etch the intermediate channel 27 in the waveguide 13 and then etch the channel 26 in the substrate 12. In an example, a first etchant may be used that is selective toward the signal amplifying material 14 (i.e., does not deleteriously affect the mask). This etchant removes those portions of the signal amplifying material 14 exposed thereto.

In one example, once the pattern 16, 16′ is formed in the signal amplifying material 14, another etchant that selectively etches the substrate 12 may be directed through the central aperture 18. This etchant will pass through the central aperture 18 and remove portions of the substrate 12 to form the channel 26 therein. In another example, once the pattern 16, 16′ is formed in the signal amplifying material 14, another etchant that selectively etches the waveguide 13 may be directed through the central aperture 18. This etchant will pass through the central aperture 18 and remove portions of the waveguide 13 to form the intermediate channel 27 therein. In this example, still another etchant that selectively etches the substrate 12 may be directed through the central aperture 18 and the intermediate channel 27. This etchant will pass through the central aperture 18 and the intermediate channel 27and remove portions of the substrate 12 to form the channel 26 therein. In other examples after the mask is formed, optical lithography may be used to form the apertures 20 and 22, and focused ion beam may be used to form the central aperture 18 and the channel 26 or channels 26 and 27.

In another example method, a mold has a replica of the apertures 18, 20, and in some instances 22, of the pattern 16, 16′. This mold is placed into contact with the UV or thermally curable polymer that is deposited on the waveguide 13 or the substrate 12. The mold transfers a negative replica of the pattern 16, 16′ of apertures to the UV or thermally curable polymer. While the mold is in contact with the UV or thermally curable polymer, the polymer is cured or partially cured. The mold is then removed and curing is completed if necessary, and the cured polymer is a mask having the negative replica of the pattern 16, 16′ defined therein. The signal amplifying material may then be deposited into the apertures of the negative replica of the pattern 16, 16′. Lift-off of the mask will result in the formation of the desirable apertures 18, 20, and in some instances 22, in the deposited signal amplifying material.

Multiple etching steps may then be performed to etch the channel 26 into the substrate 12 or to etch the intermediate channel 27 in the waveguide 13 and then etch the channel 26 in the substrate 12. In an example, a first etchant that is selective toward the substrate 12 may be directed through the central aperture 18. This etchant will pass through the central aperture 18 and remove portions of the substrate 12 to form the channel 26 therein. In another example, an etchant that selectively etches the waveguide 13 may be directed through the central aperture 18. This etchant will pass through the central aperture 18 and remove portions of the waveguide 13 to form the intermediate channel 27 therein. In this example, still another etchant that selectively etches the substrate 12 may be directed through the central aperture 18 and the intermediate channel 27. This etchant will pass through the central aperture 18 and the intermediate channel 27 and remove portions of the substrate 12 to form the channel 26 therein.

In still another example method, the signal amplifying material 14 may be deposited on the substrate 12. A helium microscope tool may be used to selectively bombard the surface of the signal amplifying material 14 with a beam of charged helium ions. This process writes sub-nanometer apertures to the signal amplifying material 14. The same tool may be used to direct the beam through the central aperture 18 to form the channel 26 in the substrate 12, or to form the intermediate channel 27 in the waveguide 13 and to form the channel 26 in the substrate 12. In this example, the larger apertures (e.g., 20) may be formed using optical lithography.

It is to be understood that the pattern 16, 16′ of apertures 18, 20 or 18, 22, 20 defines a plasmonic lens (shown as reference numeral 28 in FIGS. 3A and 3B) due, at least in part, to the fact that the pattern 16, 16′ facilitates electromagnetic energy capture and concentration. As illustrated from the top view in FIG. 3A, another example of the platform 100 includes a plurality of these plasmonic lenses 28 formed in any desirable array in the signal amplifying material 14. The arrangement of the plasmonic lenses 28 in the array may be regular or non-regular. Any number of plasmonic lenses 28 may be formed in the signal amplifying material 14 using the example methods disclosed herein to form the array. It is to be understood that the number of plasmonic lenses 28 making up any array may be limited by, for example, the period of each lens 28, the desired spacing between adjacent lenses 28, the dimensions of the signal amplifying material 14, etc. It is believed that each plasmonic lens 28 is capable of performing on its own or independently of other lenses 28, thus ignoring interference from adjacent plasmonic lenses 28. However, it is also believed that if the radiation capturing apertures 20 of adjacent lenses 28 interfere with each other, the apertures 20 will split the incident energy between them, and the split energy will then be concentrated in the respective radiation concentrating apertures 22. As such, even with some interference, performance of the respective lenses 28 should not be deleteriously affected.

FIG. 3B is a cross-sectional view of the platform 100 shown in FIG. 3A, which includes the substrate 12 supporting the signal amplifying material 14 and the array of lenses 28. In the example shown in FIG. 3B, the apertures 20, 22, 18 remain hollow. The diameter of each of the radiation capturing apertures 20 is larger than the diameter of each of the radiation concentrating apertures 22, and the diameter of each of the radiation concentrating apertures 22 is larger than the diameter of each central aperture 18. The central apertures 18 of each of the patterns 16′ and lenses 28 are aligned with the respective channel 26 formed in the substrate 12. This enables fluid containing an analyte 30 to be introduced through the channel 26 and into the central aperture 18, which will now be described further in reference to FIG. 4.

The platform 100 of FIG. 3B is shown in FIG. 4 with a fluidic system 32. The fluidic system 32 includes a housing 40 that defines a fluid pathway 38 therein. The housing 40 walls may be formed of silicon dioxide (SiO₂) or silicon nitride (Si₃N₄).

The fluid pathway 38 defined by the housing 40 may include a respective microfluidic channel (i.e., having at least one dimension ranging from about 1 micron to about 100 microns) on each side of the platform 100 that includes exposed channels 26 or apertures 18, or a respective nanofluidic channel (i.e., having at least one dimension ranging from about 30 nm to about 100 nm) on each side of the platform 100 that includes exposed channels 26 or apertures 18. The fluid pathway 38 defined by the housing 40 is in fluid communication with the channels 26 and the central apertures 18. As such, the housing 40 may be glued (e.g., via an epoxy) to the edges of the substrate 12 and the edges of the signal amplifying material 14 in a manner that will maintain fluid communication between the fluid pathway 38 and both the channels 26 and the central apertures 18. While not shown, it is to be understood that multiple channels may be defined in the fluid pathway 38, each of which leads to a channel 26 and leads away from a central aperture 18.

The housing 40 has an input port 34 and an output port 36 formed therein. The input port 34 includes an inlet that is configured to direct fluid into the fluid pathway 38. A tube or other mechanism may be operatively connected to the input port 34 to direct fluid from a fluid source (not shown) into the fluid pathway 38. The output port 36 includes an outlet that is configured to direct fluid out of the fluid pathway 38 and into, for example, an exit tube, a waste receptacle, or another mechanism (also not shown).

As mentioned above, both the input and output ports 34, 36 are in fluid communication with the fluid pathway 38, and the fluid pathway 38 is in fluid communication with each of the channels 26 and the central apertures 18. “Fluid communication,” as the term is used herein, means that fluid (e.g., gas and/or liquid) is able to freely move from the input port 34 into the fluid pathway 38, from the fluid pathway 38 into the channels 26 and the respectively aligned central apertures 18, and to the output port 36. This delivers fluid to hot spots of each of the plasmonic lenses 28. It is to be understood that fluid flow may be active or passive. In one example, positive pressure may be applied through the inlet to push the fluid into the fluid pathway 38, channels 26, and central apertures 18, negative pressure may be drawn from the outlet to pull the fluid through the fluid pathway 38, or both positive and negative pressure may be used to direct the fluid in a desirable direction through the fluid pathway 38.

In another example, the signal amplifying material 14 may be used as an electrode to direct fluid movement. For example, a voltage applied to the signal amplifying material 14 may assist in translating a DNA strand through the channel 26 and central aperture 18. In this example, SERS spectra may be recorded while the biomolecule gets stuck in the central aperture 18.

It is to be understood that instead of utilizing a fluidic system 32 to introduce the desired fluid, mechanisms (e.g., syringe pumps, tubes, etc.) that directly pump the fluid into the channels 26 may be used. This may be desirable to test different analyte solutions simultaneously. It is to be understood that the fluidic system 32 and/or another fluid delivery mechanism may also be used to clean the channels 26 and central apertures 18 after a SERS sensing operation for subsequent uses.

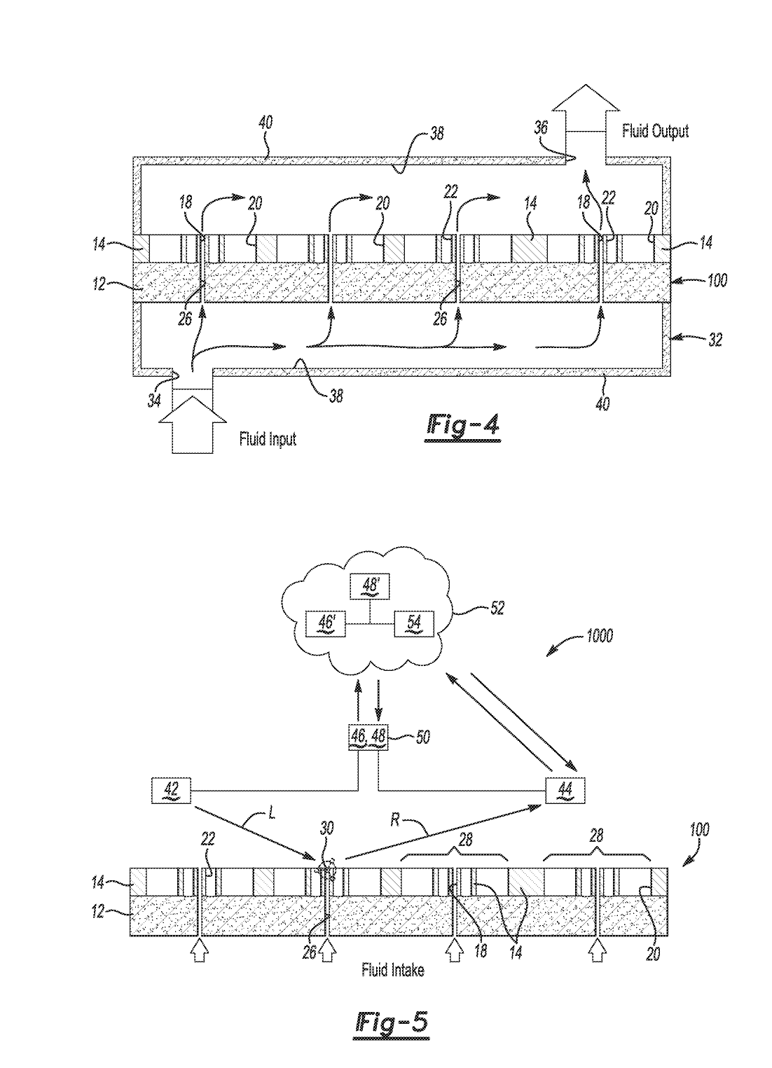

FIGS. 5 and 6 illustrate two SERS sensing systems 1000 and 1000′ that incorporate field concentrating SERS platforms 100 or 100′. Field concentrating SERS platform 100′ is similar to field concentrating SERS platform 10′, except that the platform 100′ includes an array of the plasmonic lenses 28. It is to be understood that these systems 1000, 1000′ may also incorporate the field concentrating SERS platforms 10 or 10′.

Referring now to FIG. 5, an example of the SERS sensing system 1000 is depicted which utilizes conventional free space surface enhanced Raman spectroscopy. In the system 1000, the field concentrating SERS platform 100 is positioned with respect to the SERS components (e.g., laser source 42 and detector 44).

The laser source 42 may be a light source that has a narrow spectral line width, and is selected to emit monochromatic light beams L of the wavelength λ (e.g., within the visible range, the ultra-violet range, or the near-infrared range). As some examples, the laser may have a wavelength λ of 633 nm, 785 nm, or 1064 nm. The laser source 42 may be selected from a steady state laser or a pulsed laser. The laser source 42 is positioned to project the light L onto the plasmonic lenses 28 and the signal amplifying material 14. One example of a laser source 42 is a VCSEL (vertical cavity surface emitting light) array that exposes multiple plasmonic lenses 28 to light L simultaneously. In other examples, the laser source 42 may be selected to interrogate a single plasmonic lens at a time, or multiple rows of plasmonic lenses 28 at the same time. As such, parallel sensing may be performed. A lens (not shown) and/or other optical equipment (e.g., optical microscope) may be used to direct (e.g., bend) the laser light L in a desired manner. In one example, the laser source 42 is integrated on a chip.

The detector 44 may be any photodetector that is capable of optically filtering out any reflected components and/or Rayleigh components and then detecting an intensity of the Raman scattered radiation R for each wavelength near an incident wavelength λ.

The laser source 42 and the detector 44 may also be operatively connected to a power supply (not shown).

While not shown, it is to be understood that the SERS sensing system 1000 may include a light filtering element positioned between the platform 100 and the photodetector 44. This light filtering element may be used to optically filter out any Rayleigh components, and/or any of the Raman scattered radiation R that is not of a desired region. The SERS sensing system 1000 may also include a light dispersion element positioned between the platform 100 and the photodetector 44. The light dispersion element may cause the Raman scattered radiation R to be dispersed at different angles. The light filtering and light dispersion elements may be part of the same device or may be separate devices.

During one example of the operation of the SERS sensing system 1000, fluid is introduced into the central apertures 18 through the respective channels 26. The analytes 30 in the fluid often get stuck in the central aperture 18. In an example, the central aperture 18 is functionalized to grab particular analytes of interest from fluid or gas. It is to be understood that one analyte 30 is shown in FIG. 5, but multiple analytes 30 may be present in each of the central apertures 18.

The laser source 42 is operated to emit light L toward the platform 100 (an in particular, toward the apertures 18, 20, 22. The laser source field excites the dipoles of the radiation capturing apertures 20, and from these apertures 20, the energy gets coupled via the radiation concentrating apertures 22 into the central aperture 18. The concentration of the field excites the Raman-active modes of the analyte molecules 30, which tend to become trapped in the central aperture 18. The excited analyte molecules 30 spontaneously emit the Stokes-shifted or anti-Stokes-shifted radiation R (i.e., shifted radiation R or Raman scattered light/electromagnetic radiation). The shifted radiation R is redirected toward the photodetector 44, which may optically filter out any reflected components and/or Rayleigh components and then detect an intensity of the shifted radiation R for each wavelength near the incident wavelength.

Since the quality factor Q of the signal amplifying material 14 is relatively small (e.g., ranging from about 10 to about 50), the platform 100 can, in some examples, simultaneously be resonant at both the light L frequencies and shifted radiation R frequencies. This generally occurs for shifted radiation frequencies that are shifted by a small vibrational frequency (e.g., from about 1 THz to about 40 THz). In this example, the shifted radiation R is emitted into the central aperture 18 which has a large density of states causing Purcell enhancement. The shifted radiation R in this example is coupled back into the radiation capturing apertures 20 via the radiation concentrating apertures 22.

Hardware 46 and/or programming 48 may be operatively connected to the laser source 42 and the photodetector 44 to control these components 42, 44. The same or different hardware 46 (or 46′) may receive readings from the photodetector 44, and cause the same or different programming 48 (or 48′) to produce a Raman spectrum readout, the peaks and valleys of which are then utilized for analyzing the analyte molecules.

In the example shown in FIG. 5, the local hardware 46 and/or programming 48 may be part of a device 50 that is directly connected to the components 42, 44. The local hardware 46 and/or programming 48 may be desirable to operate at least the laser source 42 and the photodetector 44. The local device 50 and/or the photodetector 44 may also be operatively connected to a cloud computing system 52. The cloud computing system 54 may be suitable for receiving data (e.g., from the device 50 or from the photodetector 44), storing data, and performing applications with such data.

The combinations of hardware 46 and programming 48 as part of the local device 50 may be implemented in a variety of fashions. For example, the programming 48 may be processor executable instructions stored on tangible, non-transitory computer readable memory media, and the hardware 46 may include a processor for executing those instructions. The memory media (e.g., hard drive, memory maintained by a server, portable medium such as a CD, DVD, or flash drive, etc.), may be used to store the instructions that, when executed by the processor, allow a user to access data sent to the memory media from the detector 44. In an example, the memory media is integrated in the same device as the processor, or it may be separate from, but accessible to that device and processor.

The cloud computing system 52 is a computing system that includes multiple pieces of hardware 46′, 54 operatively coupled over a network so that they can perform a specific computing task (e.g., receiving data from the device 50 or detector 44, enabling a user to access and/or manipulate stored SERS data, do pre- and post-processing, statistical analysis, anomaly detection, trend emergence/breakdown, jumps in data, etc.). The cloud hardware may include a combination of physical hardware 46′ (e.g., processors, servers, memory, etc.), software (i.e., associated programming 48′), and virtual hardware 54. In an example, the cloud 54 may be configured to (i) receive requests from a multiplicity of users through application client devices 50, and (ii) return request responses. In the examples disclosed herein, the requests may relate to retrieval of SERS data, building of a SERS library utilizing the user's stored data, etc.

As mentioned above, physical hardware 46′ may include processors, memory devices, and networking equipment. Virtual hardware 54 is a type of software that is processed by physical hardware 46′ and designed to emulate specific software. For example, virtual hardware 54 may include a virtual machine, i.e., a software implementation of a computer that supports execution of an application like a physical machine. An application, as used herein, refers to a set of specific instructions executable by a computing system for facilitating carrying out a specific task. For example, an application may take the form of a web-based tool providing users with a specific functionality, e.g., retrieving previously saved SERS data. Software 48′ is a set of instructions and data configured to cause virtual hardware 54 to execute an application. As such, the cloud 52 can make a particular application related to the sensing system 1000 available to users through client devices 50.

Referring now to FIG. 6, an example of the SERS sensing system 1000′ is depicted which utilizes guided mode resonance waveguide excitation of the Raman modes in trapped analytes 30. In the system 1000′, the field concentrating SERS platform 100′ is positioned with respect to the SERS components (e.g., laser source 42 and detector 44). While not shown, it is to be understood that the SERS sensing system 1000′ may also include a light filtering element positioned between the platform 100′ and the photodetector 44 and/or a light dispersion element positioned between the platform 100′ and the photodetector 44.

During one example of the operation of the SERS sensing system 1000′, fluid is introduced into the central apertures 18 through the respective channels 26 and intermediate channels 27. As noted above, the analytes 30 in the fluid often get stuck in the central aperture 18. It is to be understood that one analyte 30 is shown in FIG. 6, but multiple analytes 30 may be present in each of the central apertures 18.

The laser source 42 is operated to emit light L into the waveguide 13. The light L propagates in the waveguide 13 as shown in FIG. 6. In this example, the laser source field interacts with the entire aperture array, since the signal amplifying material 14 bounds one surface of the waveguide 13. However, when the laser source field excites the dipoles of the radiation capturing apertures 20, the electromagnetic energy may still get coupled via the radiation concentrating apertures 22 into the central aperture 18. The concentration of the field excites the Raman-active modes of the analyte molecules 30, which tend to become trapped in the central aperture 18. The excited analyte molecules 30 spontaneously emit the Stokes-shifted or anti-Stokes-shifted radiation R (i.e., shifted radiation R or Raman scattered light/electromagnetic radiation).

In this example, the shifted radiation R may also be also propagated through the waveguide 13, for example, with about 30% efficiency (i.e., reduction in laser power needed to operate the platform 100′). The increase in efficiency may depend upon the loss of shifted light. If about 100% of the shifted light can be captured and transferred at a reduced laser power, then an increase in efficiency may be realized. As such, an additional degree of enhancement may be achieved using the waveguide 13. The detector 44 is positioned to detect the shifted radiation R exiting the waveguide 13. As noted in reference to FIG. 5, the photodetector 44 may optically filter out any reflected components and/or Rayleigh components and then detect an intensity of the shifted radiation R for each wavelength near the incident wavelength.

The platform 100′ may simultaneously be resonant at both the light L frequencies and shifted radiation R frequencies, as previously described in reference to the platform 100.

The platforms 10′ and 100′ including the waveguide 13 are complementary metal-oxide semiconductor (CMOS) compatible, and may be integrated with silicon technology, such as, for example, an echellette type on-chip spectrometer (e.g., an echelle grating spectrometer).

The local device 50, and its hardware 46 and/or programming 48, alone or in combination with the cloud computing system 52, and its hardware 46, 46′ and/or programming 48′, may be used in the system 1000′ to operate the components 42, 44, receive data, store data, and perform applications with such data.

The examples of the platform 10, 10′, 100, 100′ maximize the Raman enhancement factor due to the cascaded plasmonic lens 28 concentrating the field at the central aperture 18 where analytes 30 are placed. Additional enhancements may be achieved using the waveguide-containing platforms 10′, 100′. The field concentrating SERS platforms 10, 10′, 100, 100′ are also reusable and can be readily integrated with fluidic systems and/or on-chip spectrometers.

It is to be understood that the ranges provided herein include the stated range and any value or sub-range within the stated range. For example, a range from about 30 nm to about 100 nm should be interpreted to include not only the explicitly recited limits of about 30 nm to about 100 nm, but also to include individual values, such as 35 nm, 45.5 nm, 75 nm, etc., and sub-ranges, such as from about 45 nm to about 80 nm, from about 52 nm to about 68 nm, etc. Furthermore, when “about” is utilized to describe a value, this is meant to encompass minor variations (up to +/−10%) from the stated value unless otherwise noted herein.

While several examples have been described in detail, it will be apparent to those skilled in the art that the disclosed examples may be modified. Therefore, the foregoing description is to be considered non-limiting.

What is claimed is:

1. A field concentrating surface enhanced Raman spectroscopy (SERS) platform, comprising:
a signal amplifying material;
a pattern of apertures extending through the signal amplifying material, the pattern of apertures including:
a central aperture; and
a plurality of radiation capturing apertures positioned around the central aperture, each of the radiation capturing apertures having a diameter that is larger than a diameter of the central aperture;
a substrate supporting the signal amplifying material; and
a channel extending through the substrate and at least partially aligned with the central aperture extending through the signal amplifying material.

2. The field concentrating SERS platform as defined in claim 1 wherein the pattern of apertures further includes a plurality of radiation concentrating apertures positioned between the central aperture and the plurality of radiation capturing apertures, each of the radiation concentrating apertures having a diameter that is larger than the diameter of the central aperture and smaller than the diameter of each of the radiation capturing apertures.

3. The field concentrating SERS platform as defined in claim 2 wherein:
the diameter of the central aperture is about λ/36;
the diameter of each of the radiation concentrating apertures is about λ/12;
the diameter of each of the radiation capturing apertures is about λ/4; and
λ is a wavelength of light to interrogate the field concentrating SERS platform.

4. The field concentrating SERS platform as defined in claim 2 wherein:
the diameter of the central aperture is about 3 nm;
the platform includes four radiation concentrating apertures, each of which is about 2 nm from the central aperture, and the diameter of which is about 10 nm; and
the platform includes four radiation capturing apertures, each one of which is about 5 nm from a respective one of the four concentrating apertures, and the diameter of which is about 30 nm.

5. The field concentrating SERS platform as defined in claim 1, further comprising a dielectric material at least partially filling the plurality of radiation capturing apertures.

6. The field concentrating SERS platform as defined in claim 1, further comprising:
a waveguide positioned between the signal amplifying material and the substrate; and
an intermediate channel formed through the waveguide and fluidly connecting the central aperture to the channel.

7. The field concentrating SERS platform as defined in claim 6 wherein the waveguide has a higher refractive index than a refractive index of the substrate.

8. The field concentrating SERS platform as defined in claim 1 wherein the plurality of apertures defines one plasmonic lens, and wherein the field concentrating SERS platform includes a plurality of plasmonic lenses arranged in an array in the signal amplifying material.

9. A surface enhanced Raman spectroscopy sensing system, comprising:
the field concentrating SERS platform as defined in claim 1;
a light source to project light onto the pattern of apertures; and
a detector to detect a signal emitted after the center aperture has been exposed to an analyte of interest and the pattern of apertures has been exposed to the light.

10. The SERS sensing system as defined in claim 9 wherein the field concentrating SERS platform includes a waveguide positioned between the signal amplifying material and the substrate, and wherein the light source is positioned at one end of the waveguide and the detector is positioned at an other end of the waveguide.

11. The SERS sensing system as defined in claim 9, further comprising a fluidic system to introduce a sample containing an analyte of interest to the central aperture through the channel.

12. The SERS sensing system as defined in claim 9 wherein the plurality of apertures is resonant both at a frequency of the light source and a Stokes frequency.

13. A method for making a field concentrating SERS platform, the method comprising:
depositing a signal amplifying material on a substrate;
creating a pattern of apertures in the signal amplifying material such that:
a central aperture extends through a thickness of the signal amplifying material; and
each of a plurality of radiation capturing apertures positioned around the central aperture extend through the thickness of the signal amplifying material; and
creating a channel extending through the substrate such that an end of the channel is at least partially aligned with the central aperture.

14. The method as defined in claim 13 wherein creating the pattern is accomplished via nanoimprinting and reactive ion etching.

15. The method as defined in claim 13 wherein the creating of the pattern of apertures is accomplished such that the pattern of apertures further includes a plurality of radiation concentrating apertures positioned between the central aperture and the plurality of radiation capturing apertures, each of the radiation concentrating apertures having a diameter that is larger than a diameter of the central aperture and smaller than a diameter of each of the radiation capturing apertures.

16. The method as defined in claim 15 wherein the creating of the pattern of apertures includes forming four radiation capturing apertures and four radiation concentrating apertures.
